(19) United States
(12) Patent Application Publication
(10) Pub. No.: US 2022/0048502 A1
(43) Pub. Date: Feb. 17, 2022

(54) EVENT DETECTION SYSTEM FOR ANALYZING AND STORING REAL-TIME OTHER-USER VEHICLE SPEED AND DISTANCE

(71) Applicant: Younghun KIM, Gwangmyeong-si (KR)

(72) Inventor: Younghun KIM, Gwangmyeong-si (KR)

(21) Appl. No.: 17/292,098

(22) PCT Filed: Aug. 22, 2019
(86) PCT No.: PCT/KR2019/010712

§ 371 Date: Nov. 3, 2021

(30) Foreign Application Priority Data
Nov. 12, 2018 (KR) 10-2018-0138387

(51) Int. Cl. B60W 30/095; G06K 9/00

(52) U.S. Cl. CPC B60W 30/0953; B60W 2554/4049; G06K 9/00805; B60W 30/0956

(57) ABSTRACT

A vehicle event occurrence detection system of the present invention calculates a speed and a separation distance of other vehicle, displays information of one or two vehicles with a possibility of an accident on a screen in real time, and transmits it to an external device. Accordingly, when an actual accident occurs, an exact cause of the accident can be identified based on information before and after the accident. Since the information of the vehicles is stored in a storage, it can be reproduced and checked later.

### TECHNICAL FIELD

The invention relates to an event detection system analyzing and storing speeds and distances of other vehicles in real time and more particularly, to an improved event detection system, which determines a monitoring target vehicle with a high possibility of an accident based on speeds and distances of surrounding vehicles, displays it, stores information related to it, and transmits it to a mobile device and a central server.

### BACKGROUND ART

There are many disclosed devices related to detection of a vehicle accident. Some are configured to detect occurrences of vehicle accidents and inform locations thereof while others record and transmit image data before and after the accident. Black box helps understand the accident; however, there are limitations to know the exact cause of the accident due to the lack of data including the speed of the vehicle before and after the accident.

In Korean Patent Registration No. 10-1887010 (Registration Date: Aug. 3, 2018), the applicant in this application suggested the technology, which comprises a sensor and a black box, which are operated by transmitting a first data, which includes the image of the black box, the time of the impact, and the images before and after the accident, and a second data, which includes the text information regarding the impact occurrence, to a terminal device. Since this patent transmits the event occurrence time and the images of the accident to the terminal device of the vehicle owner when the event, such as a vehicle crash, is occurred, the owner does not need to spend time and efforts to identify the images of the accident and can learn the event instantly, thereby allowing the owner to handle the accident conveniently, promptly.

The applicant researched more based on the patent above and recognized that the prevention of an accident is more important and that it is helpful for understanding the exact cause of the accident to display and store speed and distance information of surrounding vehicles before and after the time of the accident. Accordingly, the present invention is an improved system based on the patent above.

### DISCLOSURE

### Technical Problem

Accordingly, one object of the present invention is to provide an event detection system preventing a vehicle accident in advance and easily recognizing the exact cause of an accident by displaying and storing speed and distance information of other vehicles before and after the accident.

### Technical Solution

The present invention is to provide a vehicle event occurrence detection system configured to calculate a speed and a separation distance of other vehicle, display information of one or two vehicles with a possibility of an accident on a screen in real time, and transmit it to an external device, thereby enabling the exact cause of the accident to be identified based on information before and after the accident.

Specifically, an event occurrence detection system comprising: a vehicle controller mounted on a present vehicle, the vehicle controller including: an event occurrence determinator connected to a sensor or an image pick-up device mounted on the vehicle; a display controller connected to an image display device, and a storage; wherein the event occurrence determinator measures speeds and distances of objects surrounding the vehicle, wherein the event occurrence determinator determines the object In front that is closest to the front of the vehicle as a first monitoring target object when a relative speed calculated based on the speed of the object in front is more than a certain speed, and the distance of the object in front is less than a certain distance, wherein the event occurrence determinator determines the object in rear that is closest to the rear of the vehicle as a second monitoring target object when a relative speed that is calculated based on the speed of the object in rear is more than a certain speed, and the distance of the object in rear is less than a certain distance, wherein the storage stores speed and distance information of the first, and the second monitoring target object as text and image data, wherein the display controller transmits the text and image data to the image display device, thereby displaying the information of the first and the second monitoring target object.

The image display device is one of a head-up display device, a black box, a room mirror, an instruction panel, a navigation device, or a TV installed in the vehicle.

The image display device displays the speeds and the distances of the first and second monitoring target object.

The image display device is a head-up display displayed on a wind shield glass, wherein the wind shield glass displays the vehicle, the first monitoring target object in front of the vehicle, a second monitoring target object in rear of the vehicle, the speed and the distance of the first monitoring target object, and the speed and the distance of the second monitoring target object.

The event occurrence detection system further comprises a mobile device connected to the vehicle controller, wherein the data stored in the storage is transmitted to the mobile device, wherein when a user executes an application installed in the mobile device, a screen of the mobile device displays the first monitoring target object in the front of the vehicle, a second monitoring target object in the rear of the vehicle, the speed and the distance of the first monitoring target object, and the speed and the distance of the second monitoring target object.

The event occurrence detection system further comprises a central server connected to the vehicle controller, wherein the central server automatically stores and transmits the data, which is transmitted from the storage, to a cloud server when an event occurs, wherein the central server is connected to an external device of an insurance company to whom a driver allows an authority, the police, public institutions, or corporation, thereby allowing a user of the external device to check the information related to the event through the external devices.

When other vehicle exists in a vehicle blind spot in a side road next to a road that the present vehicle is being driven on, the vehicle controller determines that a second event occurs and displays speed and distance information of the other vehicle on a side mirror.

### Advantageous Effects

According to one aspect of the invention, an event detection system enables a driver or a user to identify and prove speeds and distances of his vehicle and other vehicles before and after the accident, thereby solving difficulties when investigating the scene of an accident and identifying the exact cause of the accident based on numerical data that is not detected by a black box.

In addition, the present invention enables regulation vehicles and personal vehicles to regulate overspeed vehicles and induce accident prevention activities in roads where speed cameras are not installed.

Furthermore, the present invention enables rented or commercial vehicles, including rental cars, SoCar, Uber, taxi companies, commercial cars, and autonomous taxies, to record and store data of speeds and operation thereof. Accordingly, the rented or commercial vehicles can be monitored and checked through the stored information in real time, thereby preventing potential accidents thereof.

### DESCRIPTION OF DRAWINGS

FIG. 1 is a block diagram of a vehicle event detection system according to one embodiment of the present invention.

FIG. 2 is a flow chart of an event occurrence determinator of a vehicle controller of the present invention.

FIG. 3 is a drawing showing one embodiment of an image display device of the present invention.

FIG. 4 is a drawing showing a data structure of a storage of a vehicle controller of the present invention.

FIG. 5 is a drawing showing one embodiment of a screen of a mobile device of the present invention.

FIGS. 6a and 6b are drawings showing other embodiments of image display devices of the present invention.

### MODE FOR INVENTION

Hereinafter, some embodiments of the present invention will be described in detail in conjunction with the accompanying drawings.

Regarding referral numbers in drawings, the same components are referred to as the same referral number even though they are shown in different figures. In addition, detailed explanation regarding related components and functions, which are well known to one of ordinary skill in the art, will be omitted in case it may obscure the gist of the present invention.

One characteristic of the embodiments of the present invention described below is that the invention can analyze the cause, the time, and the situation of the accident before and after it happens as well as the exact moment of the accident, by determining an occurrence of an event based on a “distance” and a “relative speed” between a present vehicle and other vehicles.

“Vehicle(s)” in this invention shall be interpreted in a broadest meaning, and thus, it includes a four-wheel-drive vehicle such as a car, a bus, and a truck, and a two-wheel-drive vehicle such as a motorcycle.

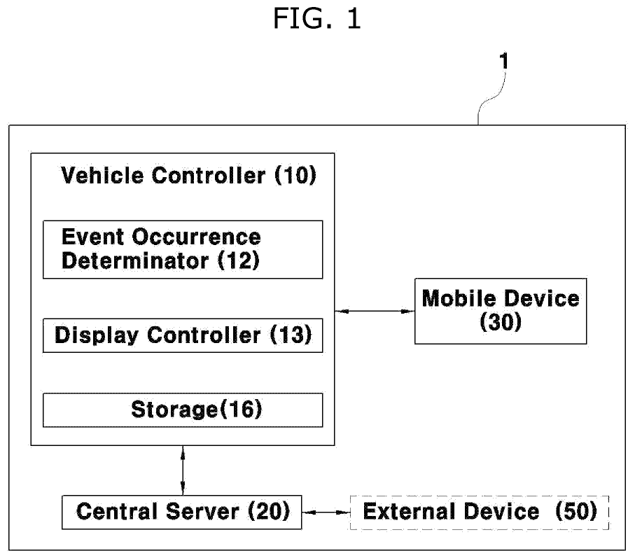

FIG. 1 is a block diagram of a vehicle event detection system 1 according to one embodiment of the present invention. The vehicle event detection system 1 comprises: a vehicle controller 10 mounted on a present vehicle, a central server 20 and a mobile device each communicating with the vehicle controller 10; and an external device 50 communicating with the central server 20. The central server 20 and the mobile device 30 are separate devices from the present vehicle. The external device 50 is optional, which is shown as a dotted line in FIG. 1, and not an essential component of the invention.

The vehicle controller 10 comprises an event occurrence determinator 12, a display controller 14, and a storage 16. The vehicle controller 10 is provided to the present vehicle as an independent module. The event occurrence determinator 12 is connected to various sensors and image pick-up devices each mounted on the vehicle. The display controller 14 is connected to each image display device driver to control a head-up display device, a black box, a room mirror, an instrument panel, a navigation, or a TV installed on the present vehicle. Preferably, the storage 16 is an exclusive memory assigned for the vehicle controller 10.

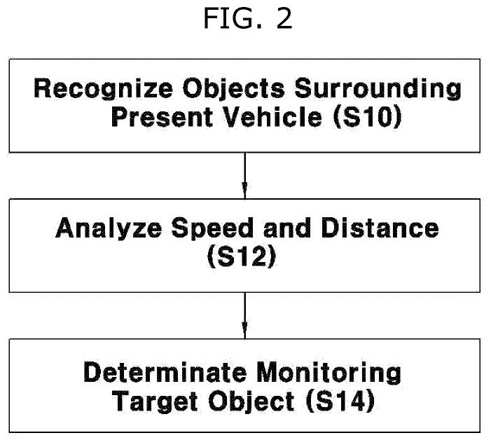

After analyzing information of vehicles surrounding the present vehicle, the event occurrence determinator 12 determines as an “event” when there is a possibility or a potential of an accident. Specifically, as illustrated in FIG. 2, the event occurrence determinator 12 detects if other vehicles, which are driven on the same road as the present vehicle does, exist within a certain range, such as 30 meters, from the present vehicle S10. Detection means are various sensors and image pick-up devices each mounted on the present vehicle. For example, the detection means may be a speed sensor, a radar, a laser, an optical camera, an ultrasound sensor, or GPS. Since these devices are currently used in smart cars and autonomous vehicles to obtain surrounding information, the vehicle controller 10 can be embodied easily.

The event occurrence determinator 12 calculates a speed and a distance of each object, which is detected within the certain range from the present vehicle S12, and determines the object as a monitoring target object S14. Specifically, the event occurrence determinator 12 determines a vehicle in front, which is closest to the front of the present vehicle, as a first monitoring target object. Additionally, the event occurrence determinator 12 determines a vehicle in rear, which is closest to the rear of the present vehicle, as a second monitoring target object. By monitoring the vehicles in front and in rear, which have high possibilities of accidents, the potential accidents can be prevented. In addition, even if the actual accident happens, the system can record the accident. An occurrence of an “event” is determined by determination of a monitoring target vehicle by the event occurrence determinator 12.

Meanwhile, the event occurrence determinator 12 may determine an occurrence of an “event” by determining a first monitoring target object when a relative speed, with respect to the present vehicle, of a vehicle in front of the present vehicle exceeds a certain speed. In addition, the event occurrence determinator 12 may determine an occurrence of an “event” by determining a second monitoring target object when a relative speed, with respect to the present vehicle, of a vehicle in rear of the present vehicle exceeds a certain speed. The relative speed exceeding the certain speed means that there is a big speed difference between the present vehicle and the other vehicle, which may lead to a crash or a collision by overspeed, abrupt deceleration, or sudden braking. In some embodiments, other relative speed criterion may be added to the event occurrence determinator 12, thereby reducing unnecessary occurrences of events and system loads.

When obtaining information of the “front view” and “rear view” of the present vehicle, the event occurrence determinator 12 may use straight signals as data for determination. The straight signals are transmitted and received by a 2-channel radar attached on a bumper of the front of the vehicle or an ultrasound sensor attached on the rear of the vehicle. In other embodiments, the event occurrence determinator 12 may use images of the front view and the rear view, which are extracted from the entire images of GPS or an around-view system. In case the present vehicle is equipped with a lane sensing system, the event occurrence determinator 12 may determine an event based on a vehicle which enters within the lanes that the lanes sensing system can detect. The detection means of the event occurrence determinator 12 mentioned above are illustrative, and a radar with more than 2-channel, other radars, a laser, or an optical camera may be used.

Even though vehicle accidents are occurred due to various reasons, such as sudden cutting in line of a vehicle which comes from an adjacent lane, those vehicles can be detected by the detection means attached on the front and the rear of the present vehicle. Therefore, it is important and effective to obtain information of the “front view” and the “rear view” of the present vehicle.

Meanwhile, since determining speeds and distances of surrounding objects or vehicles is widely known in this technical field, detailed explanation regarding this will be omitted.

The event occurrence determinator 12 according to the embodiment of the invention uses a physical distance between the present vehicle and the other vehicle, which occupies the same road as the present vehicle does, as the first criterion, and a relative speed as the second criterion to determine whether an event occurs or not. Accordingly, the event occurrence determinator 12 detects other vehicle with a high possibility of an accident.

In addition, unlike the embodiment above, the event occurrence determinator 12 may use a relative speed between the present vehicle and the other vehicle, which occupies the same road as the present vehicle does, as the first criterion, and a physical distance as the second criterion to determine whether an event occurs or not. In this instance, even though the order of the determination criteria is changed when compared to the former embodiment, the monitoring target vehicle according to the latter embodiment is the same as that in the former embodiment.

Once the event occurrence determinator 12 determines that an “event” occurs, information of the present vehicle and other vehicles, which are the first and the second monitoring target objects, are stored in the storage 16 in real time. The vehicle information includes distance and speed information according to time, distinguishable license plate information, and position information.

The display controller 14 generates image data based on information of the present vehicle and the monitoring target vehicle, which is transmitted by the storage 16, and transmits the image data to the storage 16 and also transmits it to a head-up display device, a black box, a room mirror, an instrument panel, a navigation, or a TV installed in the present vehicle. In other embodiment, the storage 16 may generate image data, store it therein, and transmit the image data to the display controller 14.

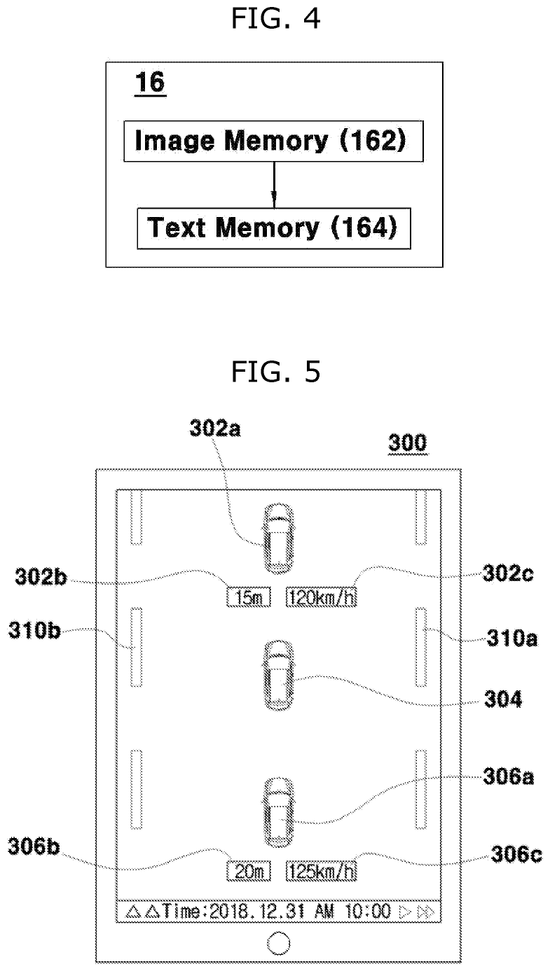

In both embodiments, as illustrated in FIG. 4, the storage 16 stores information of the monitoring target vehicles as a character 162 and an image 164. If the storage 16 is detachable, it can be inserted into a device, such as a PC, a tablet computer, or a black box, and an event or a situation before and after the accident can be analyzed using these devices. The “image” in this invention shall be interpreted as a broadest meaning including a video and moving images as well as a static image.

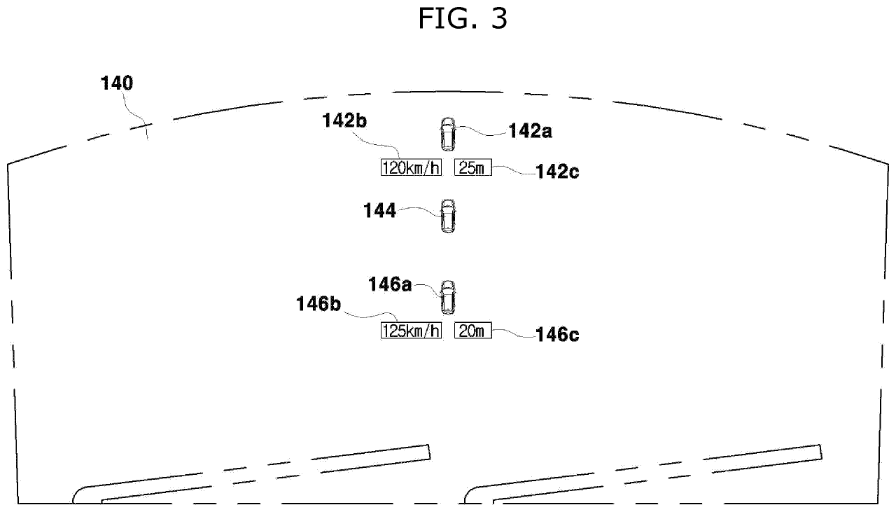

FIG. 3 is a drawing showing a head-up display as one embodiment of an image display device. FIG. 3 illustrates the head-up display connected to the display controller 14 and displaying image data on a wind shield glass 140 of the present vehicle.

The wind shield glass 140 displays the first monitoring target vehicle 142a in front of the present vehicle 144 and the second monitoring target vehicle 146a in rear of the present vehicle 144. The different trait from a head-up display is that the wind shield glass 140 does not display all or a considerable range of vehicles in front of the present vehicle, and system loads can be reduced. In addition, since only the closest vehicles to the present vehicles are selectively displayed, it can call attention to the driver, thereby reducing accidents.

In a lower part of an image of the first monitoring target vehicle 142a, speed information 142b and distance information 142c are displayed together. In a lower part of an image of the second monitoring target vehicle 146a, speed information 146b and distance information 146c are displayed together. The speed information of the first and the second monitoring target vehicle 142a, 142b are criteria to determine a cause of an accident. For example, when a crash or a collision occurs, the speed information can be used to determine which of vehicles, among the present vehicle and the other vehicles, causes the accident, and which of overspeed, abrupt deceleration, or sudden braking directly causes the crash or the collision. The distance “0” means that an accident occurs. In addition, in a state of the distance “0”, the text and the image data stored in the storage 16 are materials for analyzing the situation after the accident occurs. As known to one skilled in this technical field, if data from a collision sensor or a black box is used together, an accident occurrence and accident information before and after the accident can be analyzed comprehensively.

FIG. 3 shows a head-up display as one embodiment of an image display device, but it may be various modifications as the following.

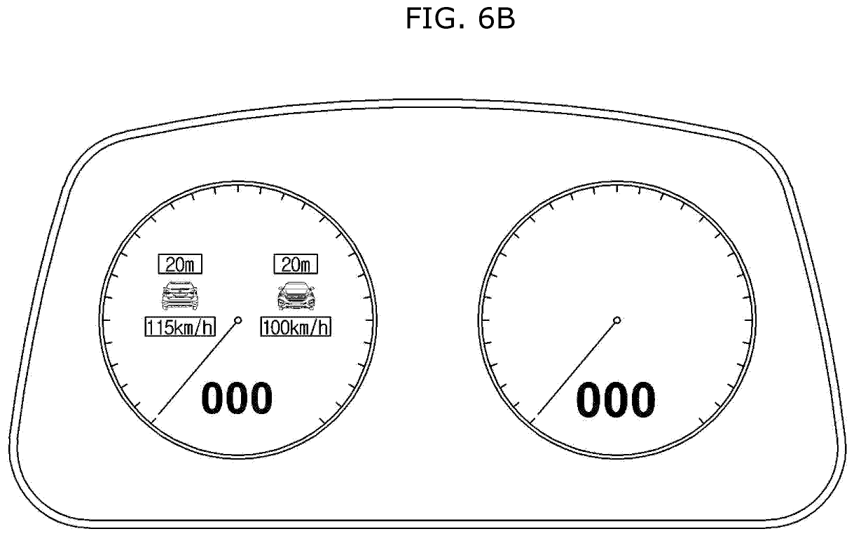

In FIG. 3, like a general head-up display, a projection of a monitoring target vehicle in front on the actual wind shield glass may replace an image displayed on the glass, and the speed and the distance information are displayed with this projection. In this instance, the display means may be a navigation device. The monitoring target vehicle may be displayed in a screen of the navigation device. In some embodiments, as illustrated in FIG. 6a, the speed and the distance information may be displayed on a room mirror, which shows the actual monitoring target vehicle in rear through the room mirror. In some embodiments, as illustrated in FIG. 6b, the speed and the distance information of the first monitoring target vehicle are displayed in red on the left side of an instrument pane, and the speed and the distance information of the second monitoring target vehicle are displayed in red on the right side of the instrument pane. In this instance, the driver can easily recognize the information of the vehicles in front and in rear as well as the information of the present vehicle. In case of FIGS. 6a and 6b, images of the monitoring target vehicle may be omitted.

The vehicle of embodiments of the present invention may include regulation vehicles of police officers as well as general vehicles, which the public drives. The vehicle can be used for regulation of overspeed vehicles and accident prevention activities.

Referring to FIG. 1 again, the mobile device 30 is connected to the vehicle controller 10. Specifically, stored character and image data in the storage 16 are transmitted to the mobile device 30 such as a cellular phone of a user. The mobile device 30 includes an application installed therein to receive the data of the storage 16 and to execute a program. When a user opens the application, the mobile device 30 displays information of the surrounding vehicles on the screen.

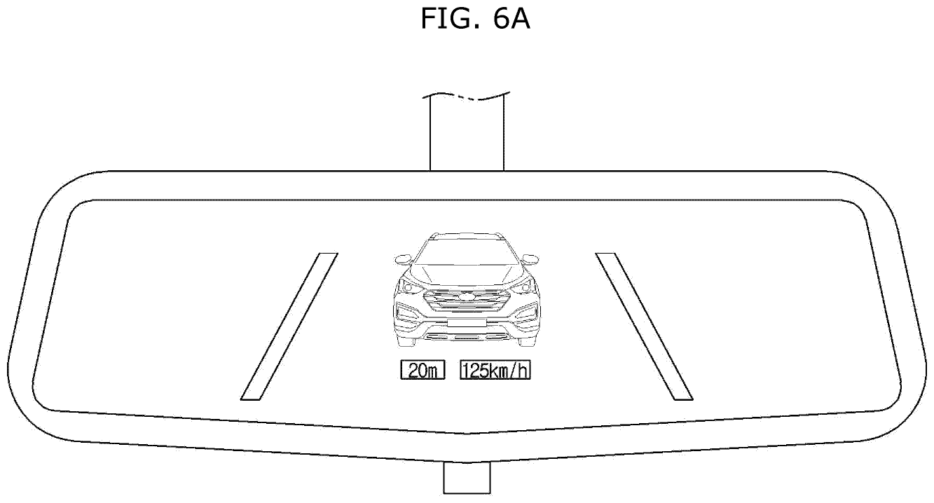

FIG. 5 illustrate an example of it, and a screen 300 of the mobile device 30 displays the first monitoring target vehicle 302a in front of the present vehicle 304 and the second monitoring target vehicle 306a in rear of the present vehicle 144, which are driven within the lanes 310a, 310b of the road that the present vehicle does, as images. In a lower part of an image of the first monitoring target vehicle 302a, speed information 302b and distance information 302c are displayed together. In a lower part of an image of the second monitoring target vehicle 306a, speed information 306b and distance information 306c are displayed together. In a lower part of the screen 300, a current time and operation buttons for reproducing previous images are displayed.

The mobile device 30 may be a third party's device as well as the driver of the present vehicle. In some embodiments, the present vehicle may be rented or commercial vehicles, such as rental cars, SoCar, Uber, taxi companies, commercial cars, autonomous taxies, and others. In this instance, data regarding how the vehicle is operated can be recorded and stored, and the third party other than the driver can check the information and monitor the vehicle in real time.

In addition, the mobile device 30 includes all electronic devices that can communicate with others, such as a cellular phone, a PC, a tablet computer, and so on.

Meanwhile, even though a vehicle or a device which can display an image data are explained above, the present invention is not limited to. In other embodiments, even in the case where image data cannot be displayed, text data 162 of speed information, time information, and position information of the vehicles can be restored and be displayed. This record restoration method is useful for old vehicles, which are not equipped with an image pick-up device. In this instance, a data parallel storage structure of the storage 16 (shown in FIG. 4) of the invention is meaningful to embody this embodiment.

Referring to FIG. 1 again, the vehicle controller 10 of the present invention is connected to the central server 20. When an event occurs, the central server 20 automatically stores and transmits images to a cloud server through a software. A client, an insurance company to whom the client allows an authority, the police, public institutions, or corporation can connect to the cloud server through the external device 50 and check the stored event. The insurance company can know the exact cause of the accident, and the police can check if there is violation of law. The external device 50 includes all electronic devices that can communicate with others, such as a cellular phone, a PC, a tablet computer, and so on.

According to the present invention described above, since the event detection system can display and store image and test information of objects including vehicles, which have risks of accidents before and after the accident, potential accidents can be prevented in advance. In addition, even if an actual accident occurs, an exact cause of an accident and the situation can be easily identified.

The present invention has been explained with a vehicle but is not limited to. The system of the present invention can be applied to a movable object such as a drone.

In addition, the invention has been explained with vehicles in front and in rear but is not limited to. The system of the present invention can detect a vehicle, which exists in a side road next to the road that the present vehicle is driven on. Specifically, when there is a vehicle which exists in a side road, especially in a vehicle blind spot, next to the road occupied by the present vehicle, the event detection system determines whether an event occurs, and display and store the vehicle information using the same process mentioned above. In this instance, the information of the monitoring target vehicle in the side road may be displayed in a side mirror but is not limited to.

In the description above, the monitoring target vehicles are described as two vehicles, but the present invention is not limited to. The event detection system may display only a single monitoring target vehicle in front. In addition, the event detection system may detect more than three vehicles and determine an occurrence of an event.

Embodiments of the present invention described above are to be considered illustrative, and the scope of the present invention shall not be restricted or limited by the foregoing description. The present invention may be varied or modified, and the appended claims are intended to cover all such modifications, enhancements, and other embodiments, which fall within the true spirit and scope of the inventive concept. The scope of the inventive concept is to be determined by the following claims and their equivalents.

What is claimed

1. An event occurrence detection system of a vehicle, the event occurrence detection system comprising:
a vehicle controller mounted on a present vehicle, the vehicle controller including:
an event occurrence determinator connected to a sensor or an image pick-up device mounted on the vehicle;
a display controller connected to an image display device, and
a storage;
wherein the event occurrence determinator measures speeds and distances of objects surrounding the vehicle,
wherein the event occurrence determinator determines the object in front that is closest to the front of the vehicle as a first monitoring target object when a relative speed calculated based on the speed of the object in front is more than a certain speed, and the distance of the object in front is less than a certain distance,
wherein the event occurrence determinator determines the object in rear that is closest to the rear of the vehicle as a second monitoring target object when a relative speed that is calculated based on the speed of the object in rear is more than a certain speed, and the distance of the object in rear is less than a certain distance,
wherein the storage stores speed and distance information of the first and the second monitoring target object as text and image data,
wherein the display controller transmits the text and image data to the image display device, thereby displaying the information of the first and the second monitoring target object.

2. The event occurrence detection system of claim 1, wherein the image display device is one of a head-up display device, a black box, a room mirror, an instruction panel, a navigation device, or a TV installed in the vehicle.

3. The event occurrence detection system of claim 2, wherein the image display device displays the speeds and the distances of the first and second monitoring target object.

4. The event occurrence detection system of claim 3, wherein the image display device is a head-up display displayed on a wind shield glass,
wherein the wind shield glass displays the vehicle, the first monitoring target object in front of the vehicle, a second monitoring target object in rear of the vehicle, the speed and the distance of the first monitoring target object, and the speed and the distance of the second monitoring target object.

5. The event occurrence detection system of claim 3, the event occurrence detection system further comprises a mobile device connected to the vehicle controller,
wherein the data stored in the storage is transmitted to the mobile device,
wherein when a user executes an application installed in the mobile device, a screen of the mobile device displays the first monitoring target object in the front of the vehicle, a second monitoring target object in the rear of the vehicle, the speed and the distance of the first monitoring target object, and the speed and the distance of the second monitoring target object.

6. The event occurrence detection system of claim 5, the event occurrence detection system further comprises a central server connected to the vehicle controller,
wherein the central server automatically stores and transmits the data, which is transmitted from the storage to a cloud server when an event occurs,
wherein the central server is connected to an external device of an insurance company to whom a driver allows an authority, the police, public institutions, or corporation, thereby allowing a user of the external device to check the information related to the event through the external devices.

7. The event occurrence detection system of claim 3, wherein when other vehicle exists in a vehicle blind spot in a side road next to a road that the present vehicle is being driven on, the vehicle controller determines that a second event occurs and displays speed and distance information of the other vehicle on a side mirror.
